(19) United States
(12) Patent Application Publication
(10) Pub. No.: US 2019/0265846 A1
(43) Pub. Date: Aug. 29, 2019

(54) DATE ENTRY USER INTERFACE

(71) Applicant: Oracle International Corporation, Redwood Shores, CA (US)

(72) Inventors: Matthew F. SHIELDS, Hudson, OH (US); Jeffrey D. MESSNER, Cleveland, OH (US)

(21) Appl. No.: 15/903,423

(22) Filed: Feb. 23, 2018

(51) Int. Cl. G06F 3/0482; G06F 3/0488; G06F 3/0484

(52) U.S. Cl. CPC G06F 3/0482; G06F 3/0485; G06F 3/04847; G06F 3/04886

(57) ABSTRACT

Embodiments are directed to receiving a date entry using a touchscreen user interface (“UI”) by receiving a request to provide a date and provide a month portion of a date entry widget. Embodiments receive from a first interaction with the UI, a selection of one of the selectable months. Embodiments provide a day portion of the date entry widget, and receive, from a second interaction with the UI, a selection of one of the selectable months. Embodiments provide a year portion of the date entry widget, where the year portion includes single year increment/decrement selectors and predefined multiple year increment/decrement selectors. Embodiments receive from multiple interactions with the UI a selection of at least one of the single year increment/decrement selectors and at least one of the predefined multiple year increment/decrement selectors and, based on the selections, enter the selected date.

### FIELD

One embodiment is directed generally to a user interface of a computer system, and in particular to the entry of a date in a user interface of a computer system.

### BACKGROUND INFORMATION

In software applications, the entry of date information is a common task and can occur multiple times in any given activity or transaction. Date information is typically entered by either typing a date into an input field (e.g., freestyle entry of a specific date) or by a calendar module/widget or a set of scrollable widgets for month, day, and year.

While such date entry implementations are commonplace, they require a number of user movements/interactions with a user interface. These user interactions may be time-consuming depending on the type of input device (e.g., mouse, keyboard, touchscreen) and the screen size of the device. For example, known calendar widgets for touchscreens typically require too many user interaction (i.e., too many taps) to change to the correct month and year and scrollable fields that are too awkward to use when scrolling through many values (e.g., trying to select a birth year of 1950 in a scrolling field that defaults to 2000).

### SUMMARY

Embodiments are directed to receiving a date entry using a touchscreen user interface (UI). Embodiments receive a request to provide a date and provide a month portion of a date entry widget, where the month portion displays all selectable months. Embodiments receive from a first interaction with the UI, a selection of one of the selectable months. Embodiments provide a day portion of the date entry widget, where the day portion displays all selectable days from the selected month, and receive, from a second interaction with the UI, a selection of one of the selectable months. Embodiments provide a year portion of the date entry widget, where the year portion includes single year increment/decrement selectors and predefined multiple year increment/decrement selectors. Embodiments receive from multiple interactions with the UI a selection of at least one of the single year increment/decrement selectors and at least one of the predefined multiple year increment/decrement selectors and, based on the selections, enter the selected date.

### BRIEF DESCRIPTION OF THE DRAWINGS

FIG. 1 is a block diagram of a computer server/system in accordance with embodiments that can implement any of the disclosed components herein.

FIG. 2 illustrates a user interface (“UI”) of customer information in accordance with one embodiment.

FIG. 3 illustrates a UI that includes a date entry widget pop-up in accordance with an embodiment.

FIG. 4 illustrates a UI with a date entry widget showing the user first touches “Jun” for the month in accordance with one embodiment.

FIG. 5 illustrates a UI with a date entry widget showing the user next touches “29” for the day in accordance with one embodiment.

FIG. 6 illustrates a UI with a date entry widget showing the user lastly enters the year in accordance with one embodiment.

FIG. 7 illustrates a UI without a date entry widget showing that the date is now entered in an Anniversary Date field in accordance with one embodiment.

FIG. 8 illustrates a UI with a date entry widget that is configured for a French-speaking user in accordance with one embodiment.

FIG. 9 illustrates a UI with a date entry widget when used in a smaller handheld device in accordance with one embodiment.

FIG. 10 illustrates a UI with a date entry widget in accordance with one embodiment.

FIG. 11 illustrates a UI with a day portion of date entry widget in accordance with one embodiment.

FIG. 12 illustrates a UI with a year portion of a date entry widget in accordance with one embodiment.

FIG. 13 illustrates a UI with the complete date now entered in accordance with one embodiment.

FIG. 14 is a flow diagram of the functionality of date entry module of FIG. 1 when providing optimized date entry using a date entry widget in accordance with one embodiment.

### DETAILED DESCRIPTION

One embodiment is a user interface that includes a date entry “widget” for quickly and efficiently entering a date. When efficiently entering dates, embodiments only need a single tap for each for the month and day, and minimal taps for the year, which can be manipulated at one or multi-year increments per tap. Embodiments make date entry as quick, easy, and intuitive as possible for users, and further accounts for leap years and locale specific date entry needs.

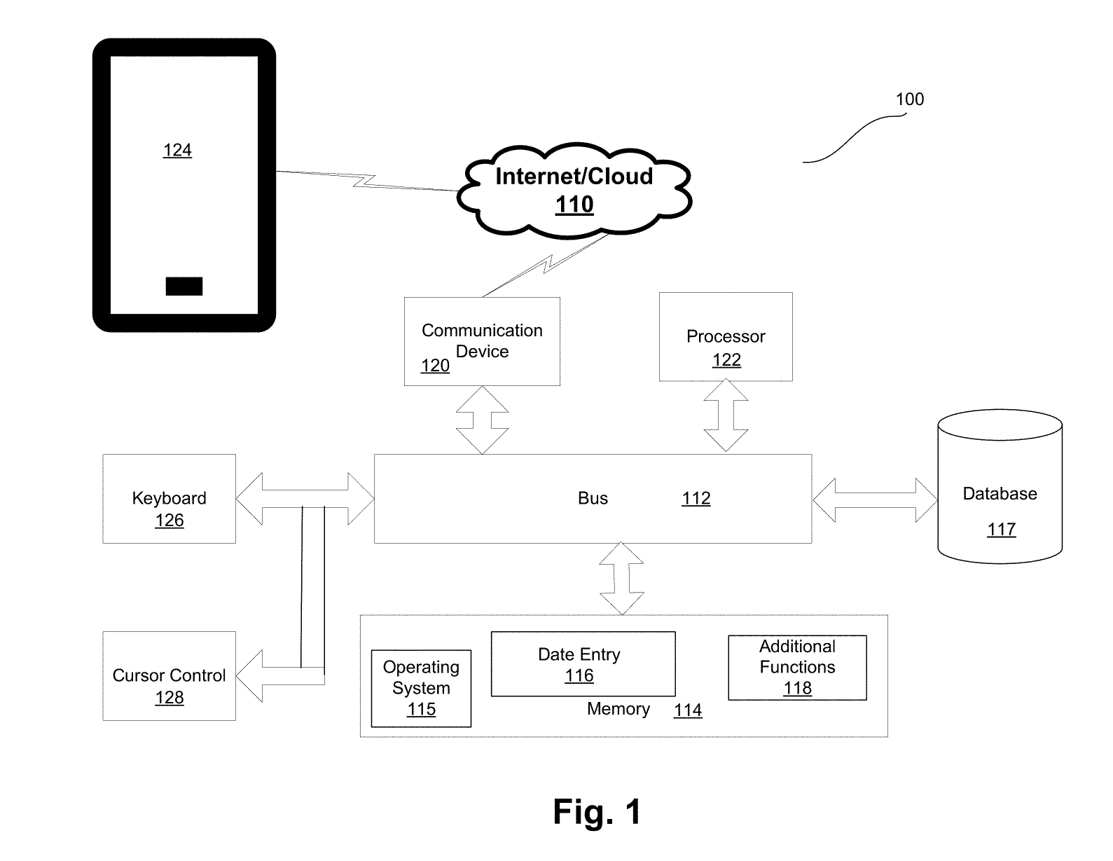

FIG. 1 is a block diagram of a computer server/system 100 in accordance with embodiments that can implement any of the disclosed components herein. As shown in FIG. 1, system 100 may include a bus device 112 and/or other communication mechanism(s) configured to communicate information between the various components of system 100, such as a processor 122 and a memory 114. In addition, a communication device 120 may enable connectivity between processor 122 and other devices by encoding data to be sent from processor 122 to another device over a network (not shown) and decoding data received from another system over the network for processor 122.

For example, communication device 120 may include a network interface card that is configured to provide wireless network communications. A variety of wireless communication techniques may be used including infrared, radio, Bluetooth®, Wi-Fi, and/or cellular communications. Alternatively, communication device 120 may be configured to provide wired network connection(s), such as an Ethernet connection.

In one embodiment, system 100 include processor 122 and other components communicating through Internet/Cloud 110, or any other communication medium, to a user device 124 such as a smartphone, tablet, etc. Device 124 can be any type of device that includes a touchscreen that enables interaction by a user using, e.g., a stylus or a finger. Device 124 may include device drivers that enable software applications to interface with hardware devices. In an example embodiment of a mobile device having a touch screen, the mobile device may include a device driver to recognize and translate user input gestures into commands or signals capable of being used by applications. The input device interface module 206 may interface with the touch screen device driver of the mobile device to receive user touch screen gestures. Device 124 also includes its own processor, memory, etc. In one embodiment, device 124 implements a browser and communicates using Hypertext Markup Language (“HTML”) to the remainder of system 100, which functions as a web server and provides web pages to device 124 either directly or indirectly (i.e., through communication with one or more other web servers).

Processor 122 may include one or more general or specific purpose processors to perform computation and control functions of system 100. Processor 122 may include a single integrated circuit, such as a microprocessing device, or may include multiple integrated circuit devices and/or circuit boards working in cooperation to accomplish the functions of processor 122. In addition, processor 122 may execute computer programs, such as an operating system 115, a data entry module 116, and other applications 118, stored within memory 114.

System 100 may include memory 114 for storing information and instructions for execution by processor 122. Memory 114 may contain various components for retrieving, presenting, modifying, and storing data. For example, memory 114 may store software modules that provide functionality when executed by processor 122. The modules may include an operating system 115 that provides operating system functionality for system 100. The modules can include an operating system 115, data entry module 116 configured to provide data entry via a user interface, and all other functionality disclosed herein, as well as other additional functionality modules 118. In one embodiment, the additional functionality is the “Retail Xstore Point-of-Service” application from Oracle Corp. In this embodiment, device 124 functions as a mobile Point-of-Service/Sale (“POS”) device, and the date entry functionality disclosed herein is functionality that is added to the “Retail Xstore Point-of-Service” application.

Non-transitory memory 114 may include a variety of computer-readable medium that may be accessed by processor 122. For example, memory 114 may include any combination of random access memory (“RAM”), dynamic RAM (“DRAM”), static RAM (“SRAM”), read only memory (“ROM”), flash memory, cache memory, and/or any other type of non-transitory computer-readable medium.

The web server portion of system 100 may further include a keyboard 126 and a cursor control device 128, such as a computer mouse, to enable a user to interface with system 100. System 100 further may include a database 117 coupled to bus 112 to provide centralized storage for modules 116 and 118 and to store, for example, POS data as well as data for displaying the UI widget for date entry, customer data, etc. Database 117 can store data in an integrated collection of logically-related records or files. Database 117 can be an operational database, an analytical database, a data warehouse, a distributed database, an end-user database, an external database, a navigational database, an in-memory database, a document-oriented database, a real-time database, a relational database, an object-oriented database, or any other database known in the art.

Although shown as a single system, the functionality of system 100 may be implemented as a distributed system. For example, memory 114 and processor 122 may be distributed across multiple different computers that collectively make up system 100. As previously disclosed, device 124 is generally a mobile device that is remotely located from the remainder of system 100, which functions as a web server. Further, one or more components of system 100 may not be included. For example, for functionality as a user or consumer device, system 100 may be a smartphone or other wireless device that includes a processor, memory, and a display, does not include one or more of the other components shown in FIG. 1, and includes additional components not shown in FIG. 1, such as an antenna, transceiver, or any other suitable wireless device component.

In order to avoid the problems of known date entry widgets/mechanisms, embodiments require only a single tap each for the month and day, and minimal taps for the year, which can be manipulated at one or ten year increments (or other increments larger than one) per tap. Embodiments are intended to make date entry as quick, easy, and intuitive as possible for users, and also account for leap years and locale specific date entry needs. Further, embodiments enable the computer or system that implements the functionality to have an improved functionality compared to known solutions, as less UI interactions need to be processed and less data in general needs to be processed and stored.

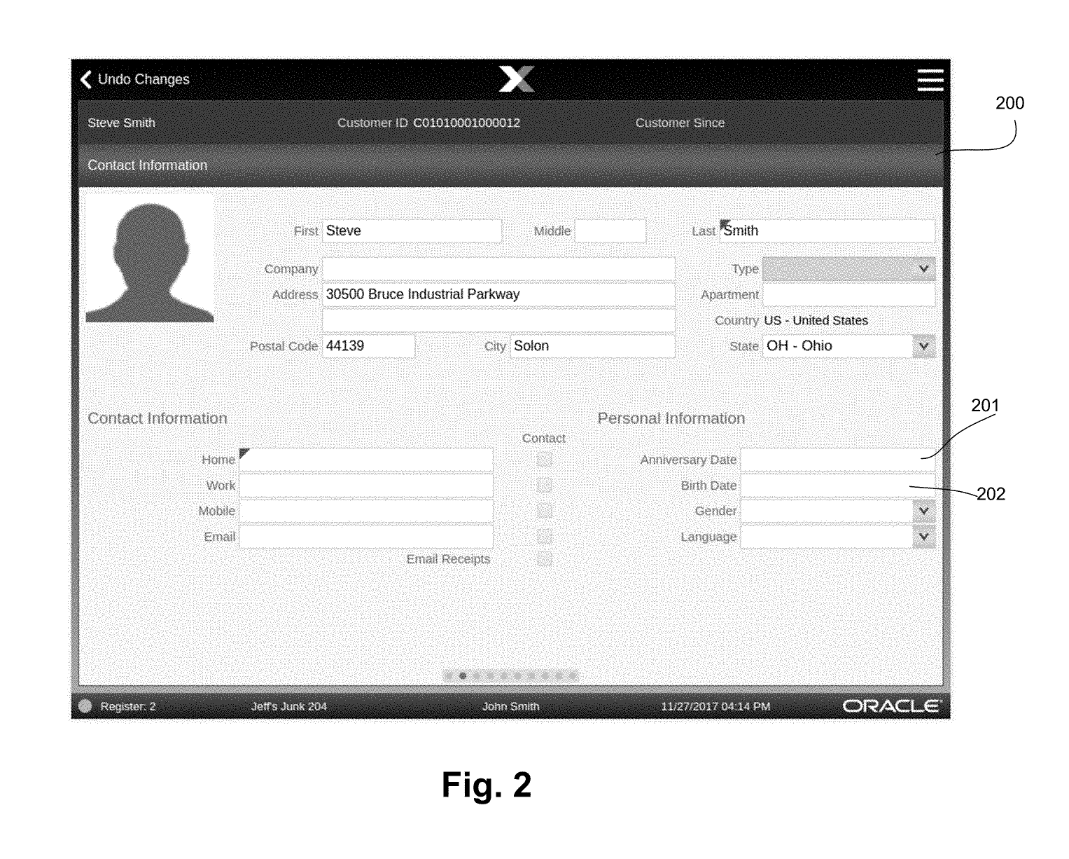

FIG. 2 illustrates a UI 200 of customer information in accordance with one embodiment. UI 200 provides an example of some date-related fields, including an Anniversary Date field 201 and a Birth Date field 202, where a user is required to enter a date. In embodiments, UI 200 and the other UIs disclosed below, are displayed on mobile device 124, which includes a touchscreen for user input via interactions but generally does not include a keyboard. Therefore, the user is generally required to enter a date via tapping/touching UI 200, or using any other types of interactions with directly on the touchscreen.

Any functionality that generates a needed date entry on mobile device 124 can be used with embodiments. For example, in one embodiment, mobile device 124 is used as a POS device, and can scan an object/product in order to purchase the object. If the object requires a date entry to purchase (e.g., the object is a bottle of wine so the purchaser's birthdate is required), a UI will be generated that includes a date entry field.

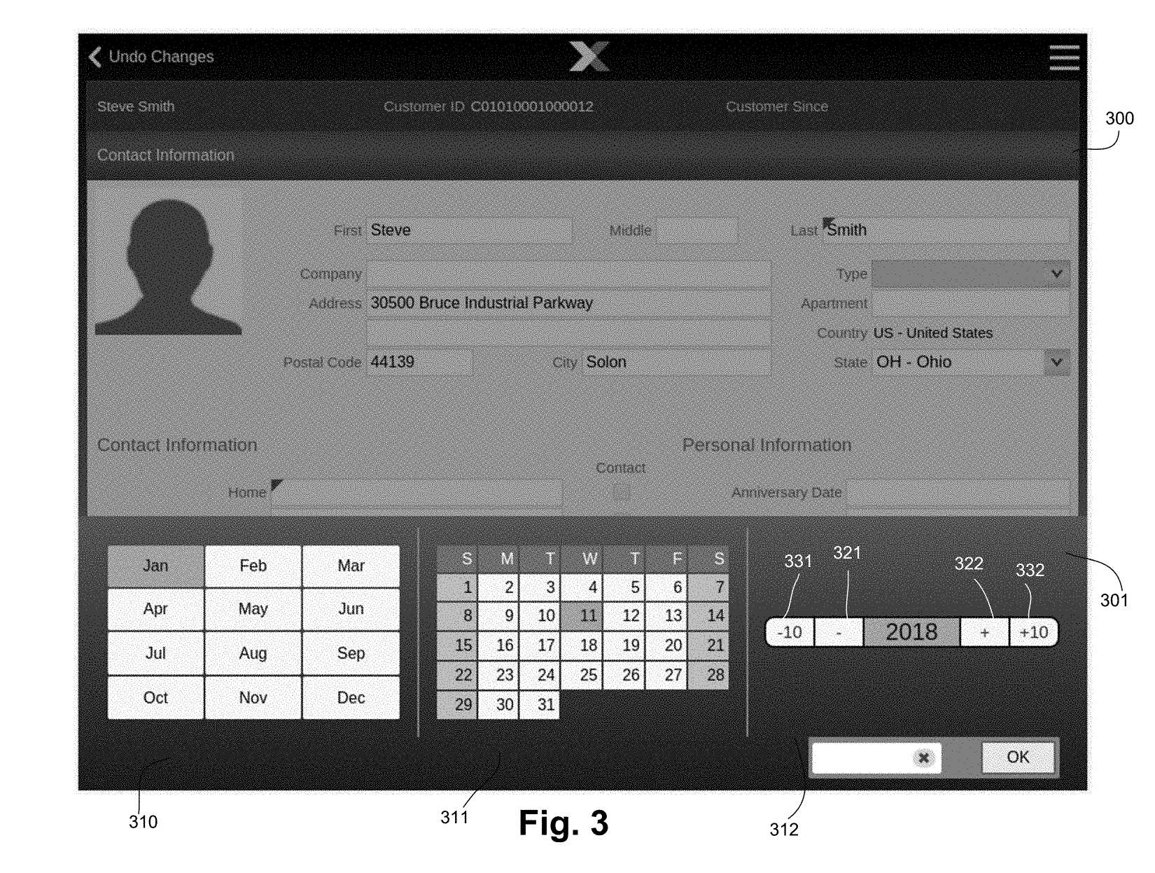

Referring again to FIG. 2, when the user touches one of the date entry fields, for example 202, a date entry widget is generated and displayed. FIG. 3 illustrates a UI 300 that includes a date entry widget pop-up 301 in accordance with an embodiment. Date entry widget 301 includes a month section 310, a day section 311 and a year section 312. Years section 312 includes increment/decrement by one year selectors 321, 322 and increment/decrement by ten years (or any other multi-year value) selectors 331, 332. Date entry widget 301 is pre-initialized with the current date in one embodiment (e.g., Jan. 11, 2018). In the embodiment shown in FIG. 3, date entry widget 301 is configured for an English-speaking user in the United States, and as such date entry widget 301 orders the date components in a way familiar to such a user (i.e., first the month, then the day, then the year). In other embodiments the ordering can be revised.

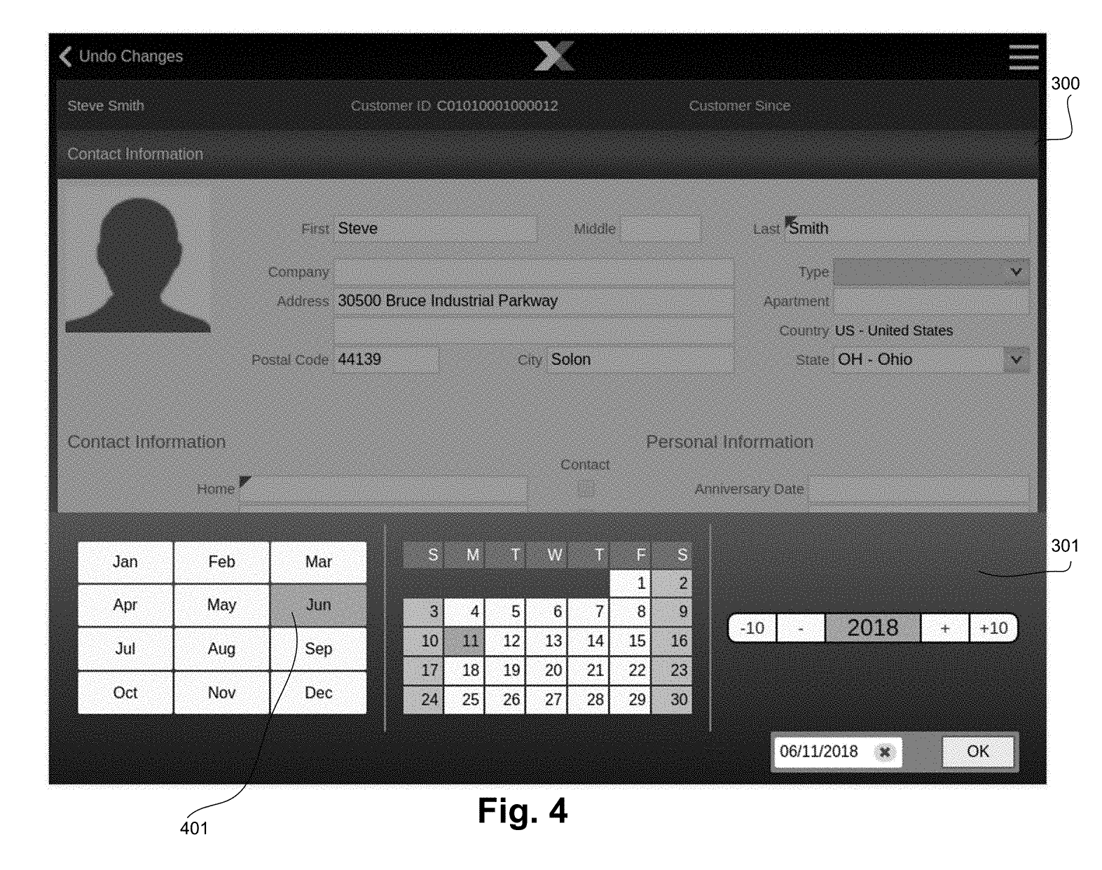

Further figures illustrate a sequence of events using embodiments of the invention when a user wants to enter a specific date, using Jun. 29, 1979 as the example date. FIG. 4 illustrates UI 300 with date entry widget 301 showing the user first touches “Jun” at 401 for the month in accordance with one embodiment.

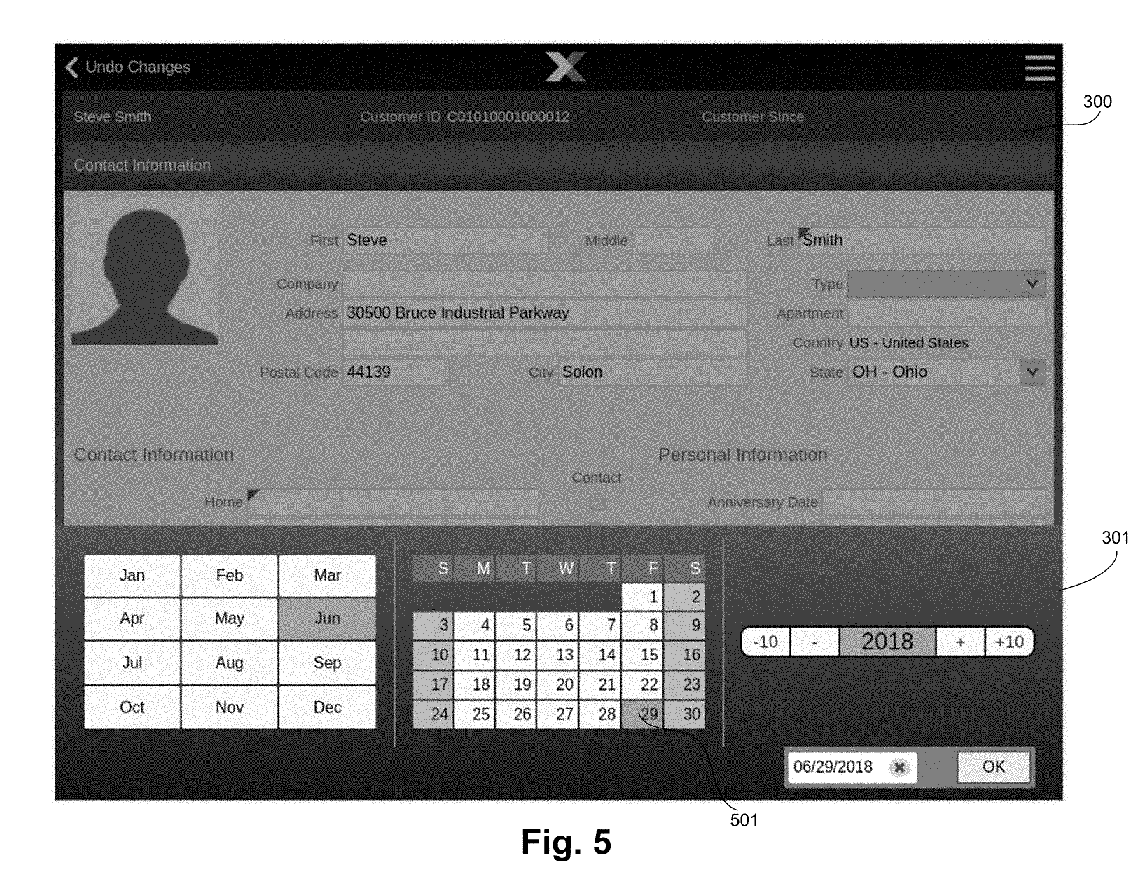

FIG. 5 illustrates UI 300 with date entry widget 301 showing the user next touches “29” at 501 for the day in accordance with one embodiment.

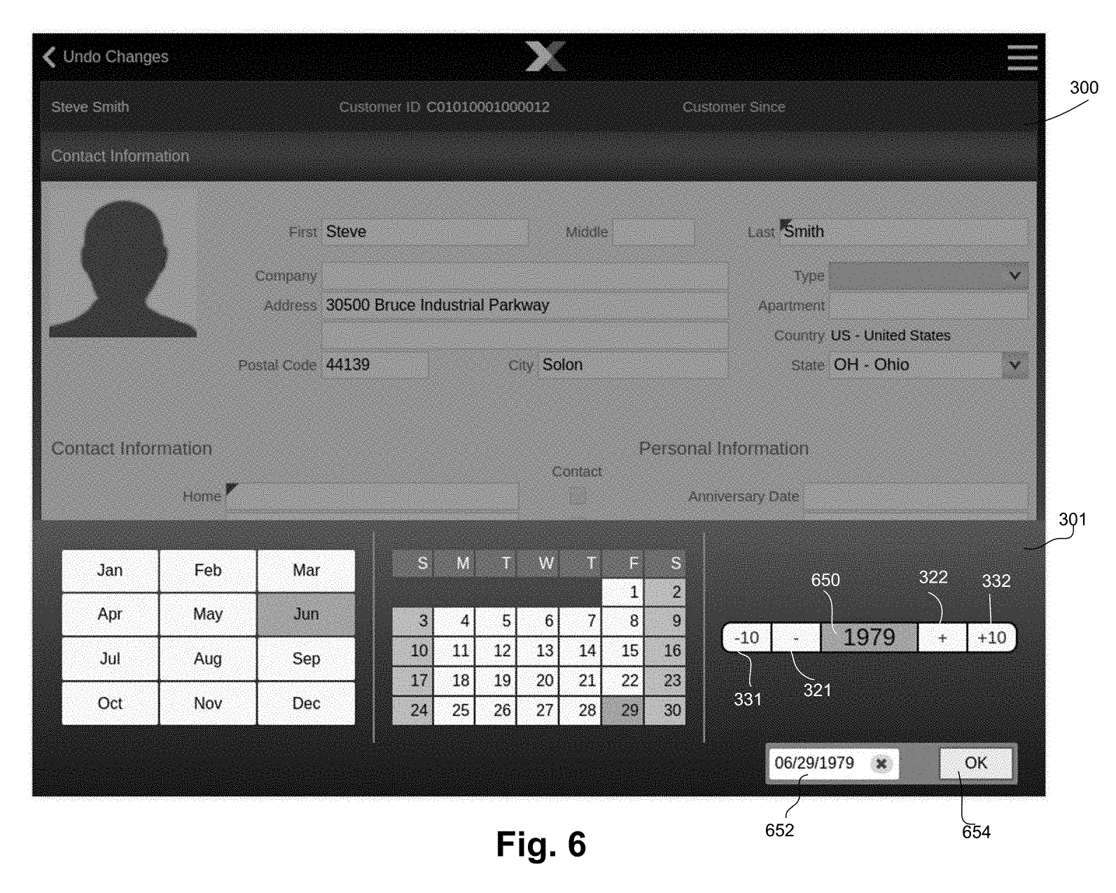

FIG. 6 illustrates UI 300 with date entry widget 301 showing the user lastly enters that year in accordance with one embodiment. To do this, the user can hit the—decrement 10 button 331 four times, each time subtracting 10 years from 2018, to get “1978”. Then the user hits the increment +1 button 322, yielding the desired year of “1979” at 650.

With known date entry solutions, the year portion entry is frequently one of the more cumbersome aspects of entering dates. The nature of retail point-of-sale applications is such that most of the dates users need to enter are typically not birth dates, where the year is likely to be decades ago. Instead, they tend to be much more recent—typically the current year, or only a few years ago. Given this, most of the time, hitting the −1 button 321 once or twice (or not at all) is typically sufficient to select the proper year in most retail applications. On the other hand, when users must enter a decades-ago year, the −10/−1/+1/+10 buttons offer an intuitive way to quickly enter the desired year, while minimizing the amount of button-presses and/or “scrolling” commonly found in known date entry widgets.

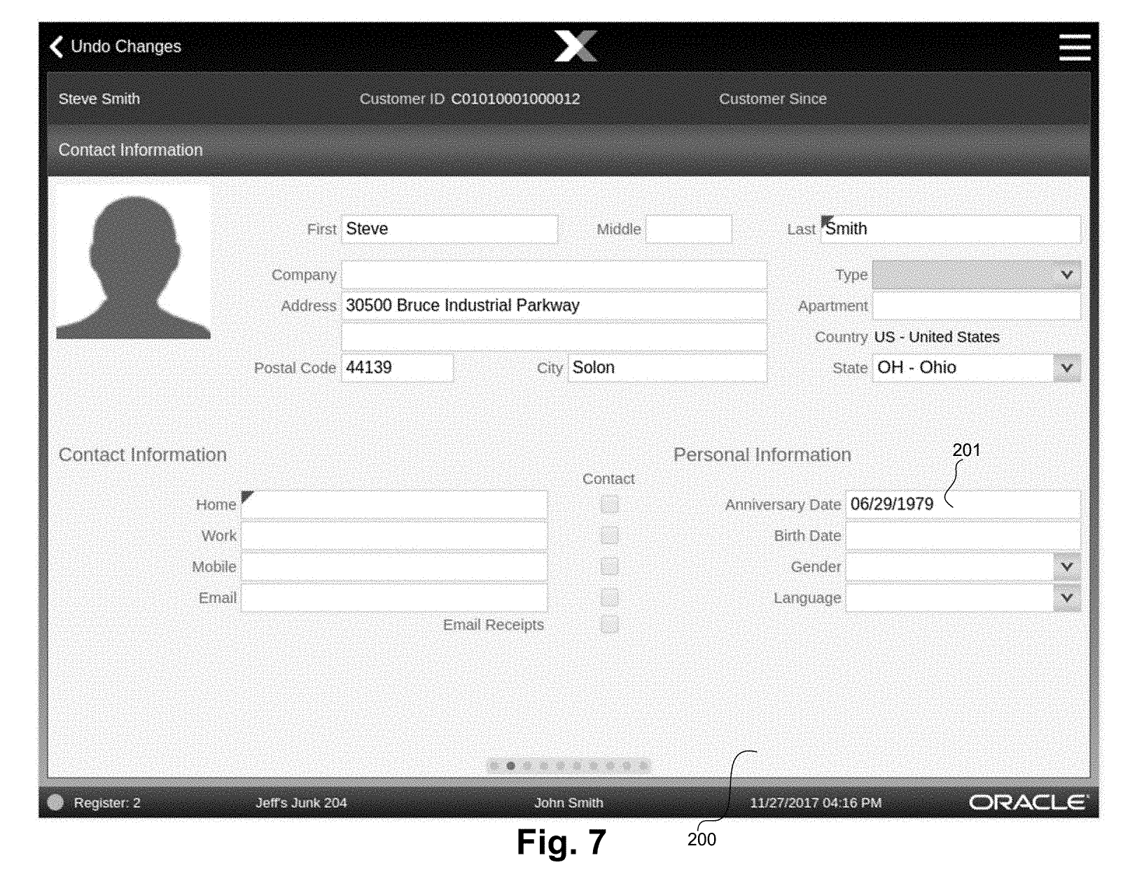

At the bottom of the widget, there is a box 652 that shows (in a locale-appropriate format) the date that the user has entered: 06/29/1979. The user now clicks the OK button 654, and the date is now entered in Anniversary Date field 201. FIG. 7 illustrates UI 200 without date entry widget 301 showing that the date is now entered in Anniversary Date field 201 in accordance with one embodiment.

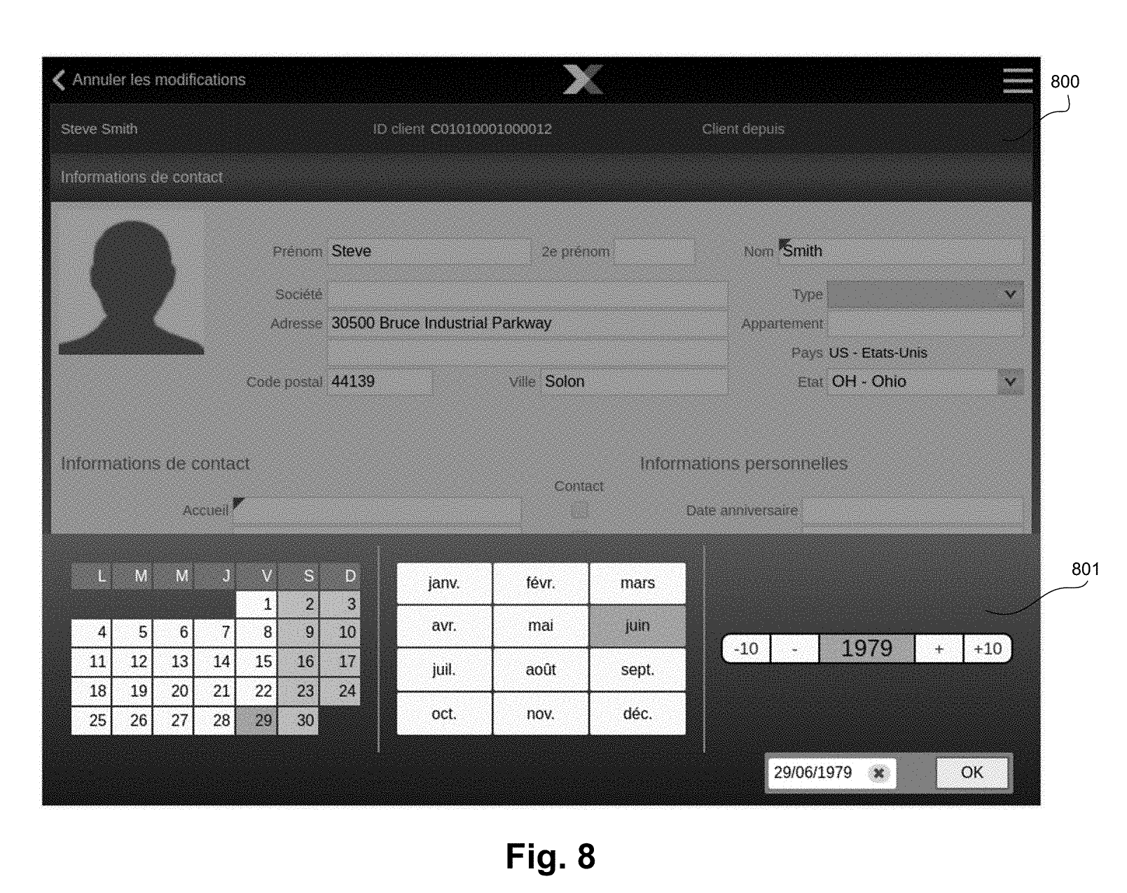

FIG. 8 illustrates a UI 800 with a date entry widget 801 that is configured for a French-speaking user in accordance with one embodiment. As shown, date entry widget 801 first shows the day, then the month, then the year. Further, the formatted date value at 805 is also in that same format (i.e., 29/06/1979). Further, as reflected in widget 801, French calendars show their days of the week starting with Monday instead of Sunday as is done in the U.S.

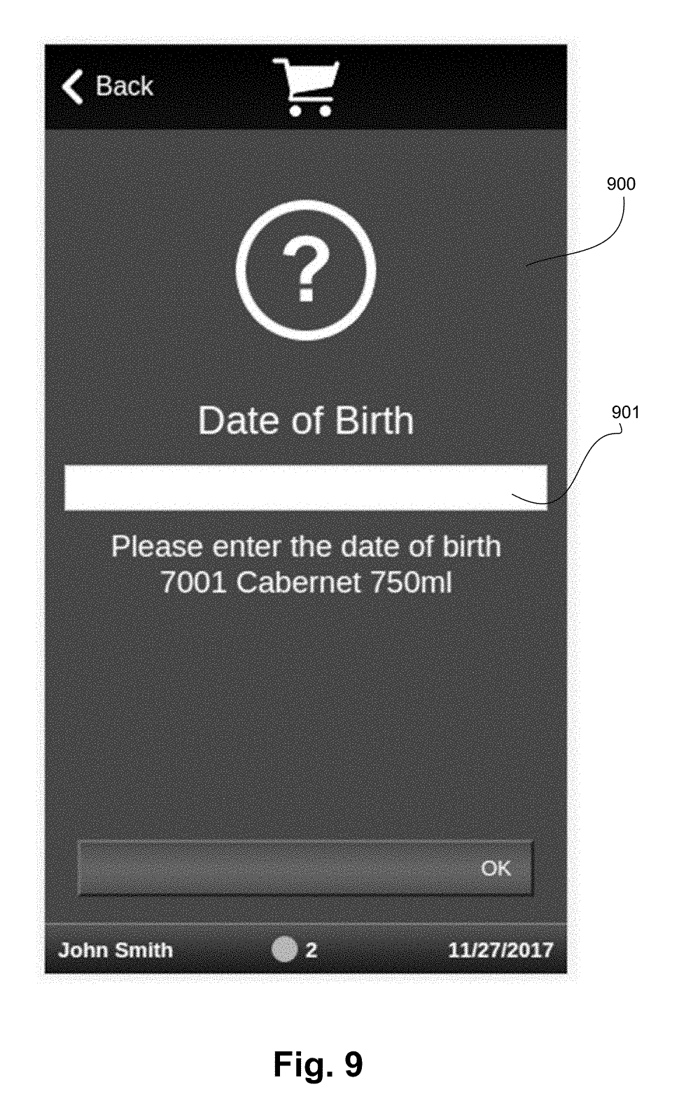

FIGS. 2-8 above generally illustrate embodiments of the invention that are implemented on a tablet or larger smartphone. Other embodiments use a revised date entry widget on a smaller device (e.g., a smartphone sized device) where display space is more limited. FIG. 9 illustrates a UI 900 with a date entry widget when used in a smaller handheld device in accordance with one embodiment. In the example of FIG. 9, a sales associate must enter a customer's birth date in field 901 to verify that the customer is of sufficient age to purchase alcohol, in response the alcohol being scanned using a barcode, a Quick Response (“QR”) code, Radio-frequency identification (“RFID”) or any other identifier recognition method. UI 900 would then be generated on the handheld device.

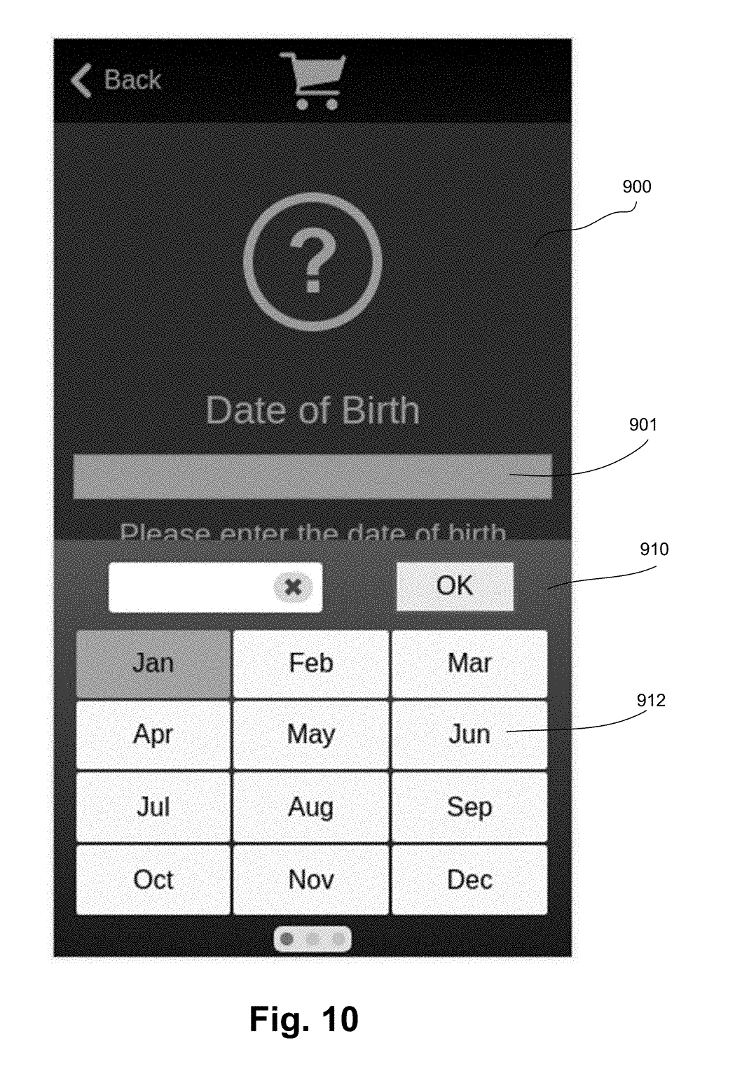

FIG. 10 illustrates UI 900 with a date entry widget 910 in accordance with one embodiment. Date entry widget 910 automatically pops up in response to the user clicking/touching/tapping on field 901. Due to the limited screen size in this embodiment, the individual parts of the date entry widget are presented one at a time, first starting with the month (since FIG. 10 shows a U.S. embodiment).

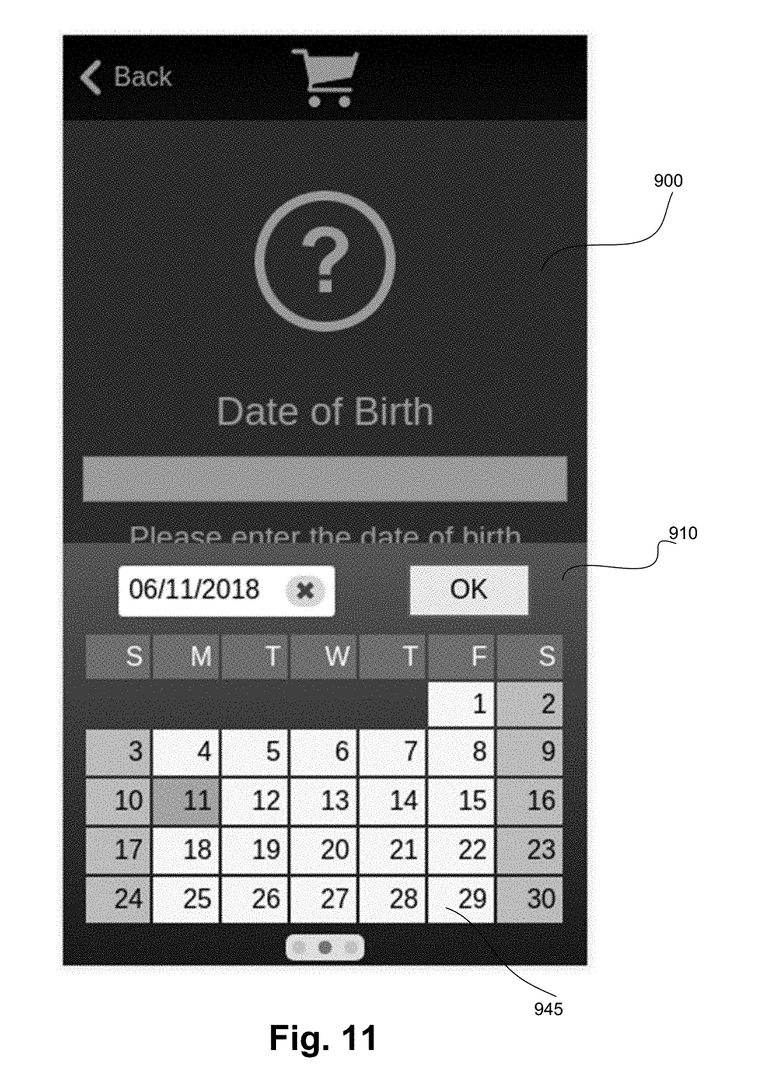

Assuming the user again wants to enter Jun. 29, 1979. The user clicks on “Jun” at 912. The user will briefly see that the “Jun” 912 button had been selected (it will be highlighted in pale blue or some other color or method), and then the date entry widget 910 will quickly “slide” the month-buttons to the left, sliding-in the day-buttons from the right. FIG. 11 illustrates UI 900 with the days portion of date entry widget 910 in accordance with one embodiment.

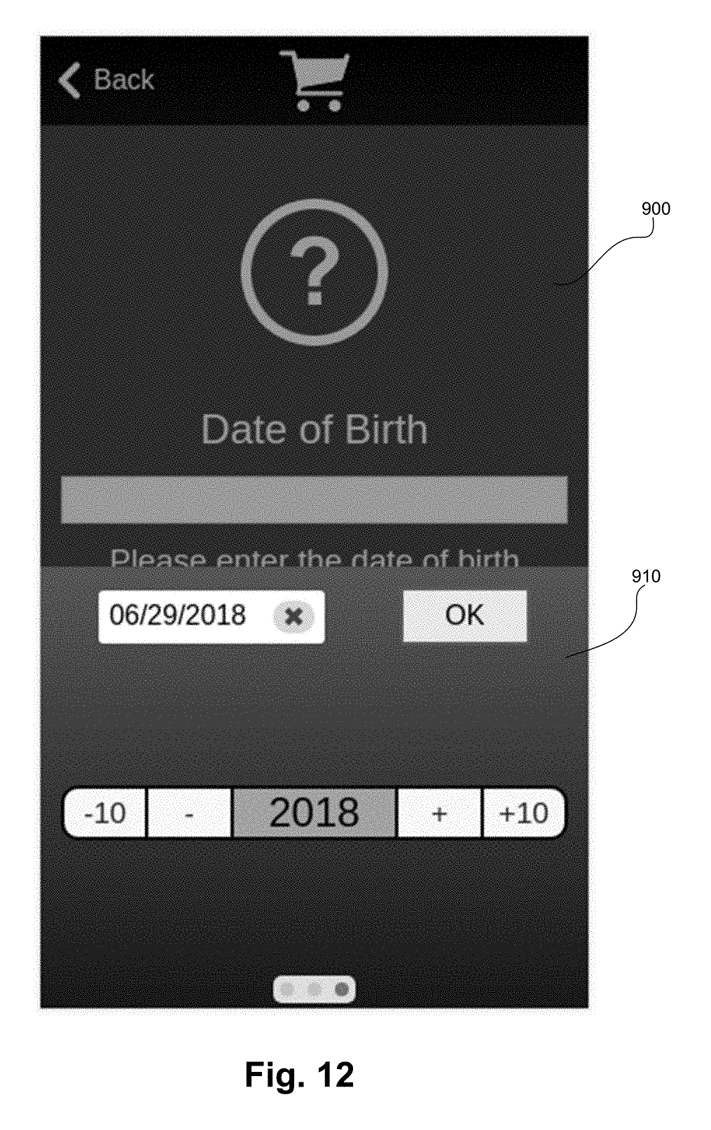

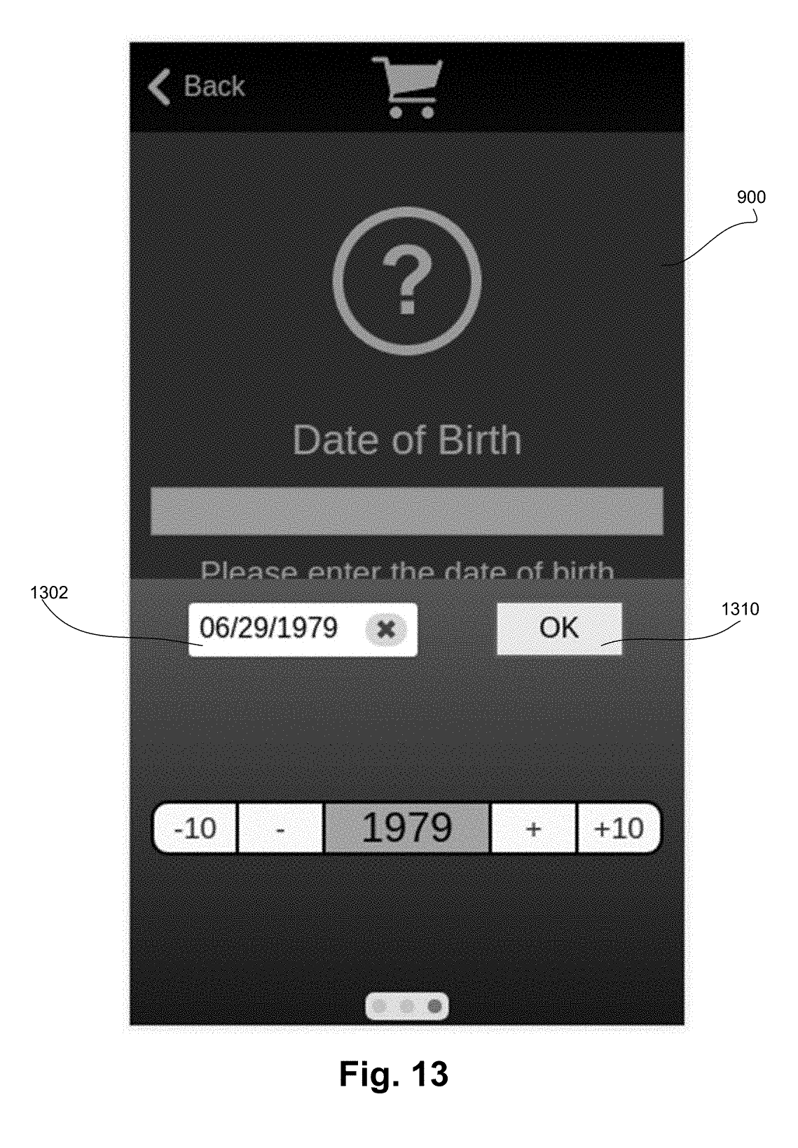

Next, the user clicks on the “29” button at 945. Date entry widget 910 then slides-out the days, and slides-in the years portion. FIG. 12 illustrates UI 900 with the years portion of date entry widget 910 in accordance with one embodiment. The user then clicks −10, −10, −10, −10, +1. FIG. 13 illustrates UI 900 with the complete date now entered at 1302 in accordance with one embodiment. Once the user is satisfied, the “OK” button 1310 can be selected. Further, embodiments allow the user to use a swipe gesture at any time during this process to modify any other parts of the date. For example, if a user wants to change the day, the user can swipe a finger on the screen from left-to-right over the date entry widget, and vice versa. The date picker panel will then slide back in from the left or right.

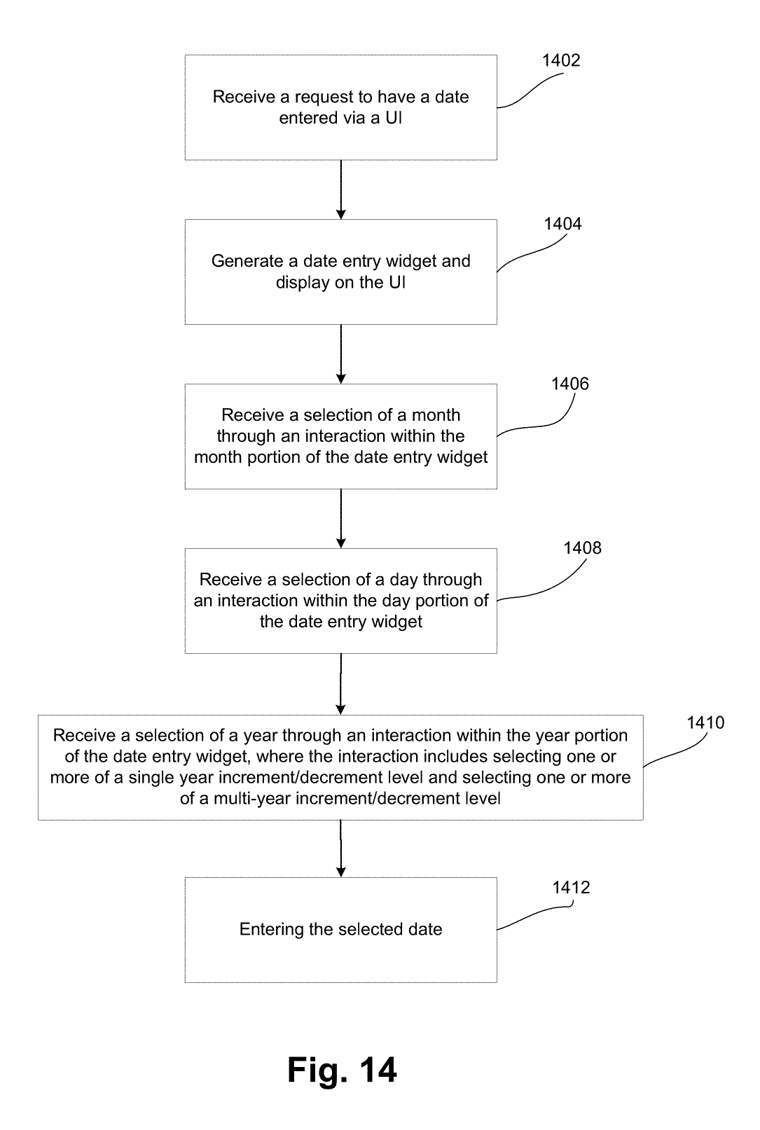

FIG. 14 is a flow diagram of the functionality of date entry module 116 of FIG. 1 when providing optimized date entry using a date entry widget in accordance with one embodiment. In one embodiment, the functionality of the flow diagram of FIG. 14 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 1402, a request is received to have a date entered. The request can be in response to a user tapping or otherwise selecting a date field on a UI that is displayed on a mobile or handheld device. The request can be generated in response to a barcode or other identifier being read by the mobile device that generated the UI.

At 1404, in response to the request, a date entry widget is generated and displayed on the UI. The date widget entry includes a month portion, a day portion, and a year portion. All portions can be displayed at once for a larger UI on a larger device, as shown in FIG. 3, or each portion can be displayed separately, for a smaller UI on a smaller device, as shown in FIGS. 9-13.

At 1406, a selection of the month is received through an interaction within the month portion of the date entry widget. The month portion displays each separate month, and the month is selected by tapping or otherwise selecting the specific month.

At 1408, a selection of the day is received through an interaction within the day portion of the date entry widget. The day portion displays each separate day, and the day is selected by tapping or otherwise selecting the specific day.

At 1410, the selection of the year is received through an interaction within the year portion of the date entry widget. The year portion displays two or more increment/decrement levels. One increment/decrement level is a single year. Another increment/decrement level is a multiple of a single year, such as a 10 year increment. The selection of the year is through one or more selections of the two or more different increment/decrement year levels. The interaction includes selecting one or more of a single year increment/decrement level and selecting one or more of a multi-year increment/decrement level.

At 1412, after the selection of an OK button, the date is entered into the system and into a database coupled to a webserver or other storage area where it may be used for further calculations.

In one embodiment, where date entry module 116 and system 100 are part of the Xstore Mobile application architecture for the Retail Xstore POS application, multiple mobile platforms are supported (e.g., iOS, Android and Universal Windows Platform). To minimize the effort of maintaining three or more separate applications (i.e., one for each mobile platform), which ordinarily would need to be written in three or different programming languages, in embodiments the majority of the application is written using standard web technologies including HTML, Cascading Style Sheets (“CSS”) and Javascript. The vast majority of the code is implemented as a Javascript program, which can run inside of a web browser. This type of application is commonly known as a “single page application” (“SPA”) and is used with embodiments of the present invention.

Although an SPA can run inside of a web browser, it can also run inside of “webview component”. A webview component is a subset of a web browser, which can be used inside of a native application. For example, an iOS developer can write a program in the Objective C language that uses a webview component which is loaded within an Xstore Mobile SPA. Similarly, an Android developer can write a program in Java which uses the Android webview component which is loaded within the same Xstore Mobile SPA, and lastly a C# language app can achieve this on the Universal Windows Platform. This is how embodiments use a single SPA that run on three or more different mobile platforms using generally the same code at its core.

In one embodiment, the Xstore Mobile SPA is an application written mostly in Javascript. As with any SPA, the Javascript code is able to create and manipulate HTML elements (along with CSS markup) on the fly. The job of the webview component (which is the heart of any web browser) is to interpret this dynamically created/manipulated HTML+CSS, and render the results on the screen.

The source code for such applications is very commonly organized into “components”. Each component is in charge of manipulating some part of the user interface that is seen on the screen and used by users. Components are also “composable”, meaning a component may be composed of one or more other components, as in parent-children relationship, where a child component is responsible for a more narrowly-defined piece of functionality. The total hierarchical aggregation of components ultimately makes up the entire application in one embodiment.

For example, for a “customer maintenance form” such as shown in FIG. 2, embodiments may include a “CustomerFormWidget” component, which contains many “TextFieldWidgets” child components. The “CustomerFormWidget” may contain the logic that knows it must display its “TextFieldWidgets” in the user interface, where each text field encompasses some aspect of customer data such as first name, last name, address, birth date, etc. The CustomerFormWidget may also contain logic that can let a user express their desire to make changes to the various fields, to save their changes to a database, to abandon any changes they have made, etc.

Components can also be programmed to communicate to each other, and take different actions based on certain events happening. For example, the TextFieldWidgets component for a zip-code may be programmed to send a signal to the CustomerFormWidget when a user enters a zip-code. In response to this signal, the CustomerFormWidget may consult a database, and then automatically populate the contents of the address, city, and state TextFieldWidgets with the correct values for that zip-code.

Embodiments of date entry module 116 includes a component referred to as “DateFieldWidget” which produces an HTML element that appears to be a “text input box”. Ordinarily, an application would create an HTML <input> element in order to accept keyboard-input from a user. However, the DateFieldWidget in accordance with embodiments instead produces a <div> element with custom CSS styling such that it looks exactly like an <input> element.

Therefore, in embodiments, inside of a CustomerFormWidget, a DateFieldWidget is used to represent any date-based customer attribute instead of a TextFieldWidget, such as with fields 201, 202 of FIG. 2.

In embodiments, a field may or may not be pre-populated with a value, depending on the circumstances. For example, when a user is using embodiments to maintain customer information, the customer's birth date may or may not already be stored in the application's database (i.e., database 117). A user may wish to add this piece of information, or may wish to modify or correct it, as circumstances warrant.

A DateFieldWidget, when populated with a date value, will always display that date value in a “human readable” format which conforms to the region and/or language standards of the user's locale. Internally, the date value is stored in a more abstract representation independent of locale.

The DateFieldWidget is programmed to monitor its <div> HTML element to detect when it receives “input focus”. HTML elements may receive input focus in a variety of ways, the most common way being the result of a user directly touching the widget, on the screen, with their finger, expressing their intent to add or modify a date value.

Normally, a webview's response to an HTML <input> element receiving input focus is to (1) place a “cursor” inside of the text input box, and (2) send a signal to the device's operating system directing it to pop-up the “on screen keyboard”, so that the user can start entering data into the box.

In contrast, with embodiments of the invention, when the DateFieldWidget's <div> element receives input focus (e.g., the user has touched it on the screen), the DateFieldWidget responds by sending a signal to another components called DateEntryWidget. Upon receiving this signal, the DateEntryWidget creates and displays a “date entry on-screen keyboard” (i.e., date entry widget 301 of FIG. 3).

The DateEntryWidget component in accordance to embodiments includes the following:
the DayPickerWidget;
the MonthPickerWidget;
the YearPickerWidget;
a label that displays the formatted date value as it is being modified by the user (i.e., making the values “human readable”, as in “Jan 29, 2018”);
an OK button which allows a user to indicate that the user is done editing the date value.

As part of orchestrating its components, the DateEntryWidget in embodiments determines the order in which to present the three picker widgets (i.e., day-month-year, month-day-year, etc.) such that it conforms to the region and/or language standards of the user's locale.

The DateEntryWidget is also aware of which device form factor it is running upon (e.g., a handheld “smartphone” device, or a “tablet” device).

The Xstore Mobile application is based on a Model View Presenter architecture in one embodiment. Many components in the application can conceptually be broken up into these three aspects—its model, its view (or views), and its presenter aspects. The DateEntryWidget takes advantage of this architecture by choosing to use one of its two views (e.g., one view for handheld, a different view for tablet) when it needs to lay out the HTML elements necessary to display itself on the screen.

A view can be considered a sort of template which contains the essential HTML structure and CSS styling that lays out all of the core pieces of the DateEntryWidget. This allows the same model (which is “data”, like the date) and the same presenter (which is code or business logic) to be used, unchanged, to function regardless of how the view makes everything appear.

The DayPickerWidget is also coded to be sensitive to the user's locale. It employs a “calendar” style layout of all of the days of the month. The days of the week are labeled at the top of this calendar, and the locale is used to determine if the first day of the week is a Sunday or a Monday.

The currently selected month and year also affect how the DayPickerWidget arranges the days using algorithms that can quickly calculate which day of the week each particular day falls upon. For example, Jan. 1, 2018 falls on a Sunday (see FIG. 3), while Jun. 1, 2018 falls on a Friday (see FIG. 4). The DayPickerWidget rearranges each days of the month under its correct day of the week, on the fly, each time the user makes any adjustment to either the month or the year.

The DayPickerWidget is also sensitive to the number of days that are applicable to certain months (e.g., 30, 31, 28, or 29). Leap years are also taken into account, so that February shows 28 or 29 days as dictated by the currently selected year.

The user finally clicks the OK button (e.g., OK button 654) to express his satisfaction that the desired date has been expressed in the DateEntryWidget. This sends a signal back to the DateFieldWidget to now display the newly entered date value.

Alternatively, a user may decide to abandon making any adjustments. In one embodiment, simply clicking any part of the screen outside of the DateEntryWidget will cause it to hide itself, and it will not send any signal to the original DateFieldWidget, leaving unmodified its original date value (or empty value) it contained before the user first touched it.

As disclosed, embodiments provide functionality to allow a date to be entered on a touchscreen with minimal number of required interactions with a UI. The reduced number of interactions improve the functioning of both the mobile device that provides the UI as well as the web server that receives the results of each interaction and stores the date entry. The functionality of the UI itself, and the process of generating the UI, reduces the number of interactions required by a user to enter a date.

Several embodiments are specifically illustrated and/or described herein. However, it will be appreciated that modifications and variations of the disclosed embodiments are covered by the above teachings and within the purview of the appended claims without departing from the spirit and intended scope of the invention.

1. A method of receiving a date entry using a touchscreen user interface (UI), the method comprising:
receiving a request to provide a date;
providing a month portion of a date entry widget, wherein the month portion displays all selectable months;
receiving, from a first interaction with the UI, a selection of one of the selectable months;
providing a day portion of the date entry widget, wherein the day portion displays all selectable days from the selected month;
receiving, from a second interaction with the UI, a selection of one of the selectable days;
providing a year portion of the date entry widget, wherein the year portion comprises single year increment/decrement selectors and predefined multiple year increment/decrement selectors based on predefined multiple years, each increment/decrement selector requiring a separate tap for each entry;
receiving from multiple interactions, comprising multiple taps, with the UI a selection of at least one of the single year increment/decrement selectors and at least one of the predefined multiple year increment/decrement selectors, wherein each selection of a single year increment selector increments the year portion by one year, each selection of a single year decrement selector decrements the year portion by one year, each selection of a multiple year increment selector increments the year portion by the predefined multiple years, and each selection of a multiple year decrement selector decrements the year portion by the predefined multiple years; and
based on the selections, entering the selected date.

2. The method of claim 1, wherein the predefined multiple year increment/decrement selectors comprise ten year increment/decrement selectors.

3. The method of claim 1, wherein the request is in response to receiving an identifier of a product.

4. The method of claim 1, wherein the request is in response to a selection of a date field on the UI.

5. The method of claim 1, further comprising, within a Model View Presenter architecture, providing a first view that displays the month portion, the day portion, and the year portion simultaneously on a single UI, or providing a second view that displays the month portion, the day portion, and the year portion on individual UIs.

6. The method of claim 5, wherein providing the first view or providing the second view is based on a form factor of a device that comprises the touchscreen UI.

7. The method of claim 1, wherein an order of providing the month portion, the day portion and the year portion depends on a locale of a device that comprises the touchscreen UI.

8. A non-transitory computer-readable medium having instructions stored thereon that, when executed by a processor, cause the processor to receive a date entry using a touchscreen user interface (UI), the receiving the date entry comprising:
receiving a request to provide a date;
providing a month portion of a date entry widget, wherein the month portion displays all selectable months;
receiving, from a first interaction with the UI, a selection of one of the selectable months;
providing a day portion of the date entry widget, wherein the day portion displays all selectable days from the selected month;
receiving, from a second interaction with the UI, a selection of one of the selectable days;
providing a year portion of the date entry widget, wherein the year portion comprises single year increment/decrement selectors and predefined multiple year increment/decrement selectors based on predefined multiple years, each increment/decrement selector requiring a separate tap for each entry;
receiving from multiple interactions, comprising multiple taps, with the UI a selection of at least one of the single year increment/decrement selectors and at least one of the predefined multiple year increment/decrement selectors, wherein each selection of a single year increment selector increments the year portion by one year, each selection of a single year decrement selector decrements the year portion by one year, each selection of a multiple year increment selector increments the year portion by the predefined multiple years, and each selection of a multiple year decrement selector decrements the year portion by the predefined multiple years; and
based on the selections, entering the selected date.

9. The computer-readable medium of claim 8, wherein the predefined multiple year increment/decrement selectors comprise ten year increment/decrement selectors.

10. The computer-readable medium of claim 8, wherein the request is in response to receiving an identifier of a product.

11. The computer-readable medium of claim 8, wherein the request is in response to a selection of a date field on the UI.

12. The computer-readable medium of claim 8, further comprising, within a Model View Presenter architecture, providing a first view that displays the month portion, the day portion, and the year portion simultaneously on a single UI, or providing a second view that displays the month portion, the day portion, and the year portion on individual UIs.

13. The computer-readable medium of claim 12, wherein providing the first view or providing the second view is based on a form factor of a device that comprises the touchscreen UI.

14. The computer-readable medium of claim 8, wherein an order of providing the month portion, the day portion and the year portion depends on a locale of a device that comprises the touchscreen UI.

15. An apparatus that receives a date entry using a touchscreen user interface (UI), the apparatus comprising:
a processor coupled to stored instructions;
the UI implemented by the processor, wherein functionality of the UI comprises:
receiving a request to provide a date;
providing a month portion of a date entry widget, wherein the month portion displays all selectable months;
receiving, from a first interaction with the UI, a selection of one of the selectable months;
providing a day portion of the date entry widget, wherein the day portion displays all selectable days from the selected month;
receiving, from a second interaction with the UI, a selection of one of the selectable days;
providing a year portion of the date entry widget, wherein the year portion comprises single year increment/decrement selectors and predefined multiple year increment/decrement selectors based on predefined multiple years, each increment/decrement selector requiring a separate tap for each entry;
receiving from multiple interactions, comprising multiple taps, with the UI a selection of at least one of the single year increment/decrement selectors and at least one of the predefined multiple year increment/decrement selectors, wherein each selection of a single year increment selector increments the year portion by one year, each selection of a single year decrement selector decrements the year portion by one year, each selection of a multiple year increment selector increments the year portion by the predefined multiple years, and each selection of a multiple year decrement selector decrements the year portion by the predefined multiple years; and
based on the selections, entering the selected date.

16. The apparatus of claim 15, wherein the predefined multiple year increment/decrement selectors comprise ten year increment/decrement selectors.

17. The apparatus of claim 15, wherein the request is in response to receiving an identifier of a product.

18. The apparatus of claim 15, wherein the request is in response to a selection of a date field on the UI.

19. The apparatus of claim 15, the functionality further comprising, within a Model View Presenter architecture, providing a first view that displays the month portion, the day portion, and the year portion simultaneously on a single UI, or providing a second view that displays the month portion, the day portion, and the year portion on individual UIs.

20. The apparatus of claim 19, wherein providing the first view or providing the second view is based on a form factor of a device that comprises the touchscreen UI.
